(19) United States
(12) Patent Application Publication
(10) Pub. No.: US 2022/0245060 A1
(43) Pub. Date: Aug. 4, 2022

(54) System and Method for Automated Testing

(71) Applicant: The Toronto-Dominion Bank, Toronto (CA)

(72) Inventors: Aayush KATHURIA, Brampton (CA); Jaskaran SINGH, Etobicoke (CA); Syed Jubair HOSSAIN, Mississauga (CA)

(73) Assignee: The Toronto-Dominion Bank, Toronto (CA)

(21) Appl. No.: 17/248,716

(22) Filed: Feb. 4, 2021

(51) Int. Cl. G06F 11/36; G06F 11/32

(52) U.S. Cl. CPC G06F 11/3688; G06F 11/3684; G06F 11/321; G06F 11/368; G06F 11/3692

(57) ABSTRACT

A system and method are provided for automated testing. The method includes connecting to a plurality of testing frameworks, receiving first test data and a first test state from a first testing framework of the plurality of testing frameworks, storing the first test data and the first test state in a test repository, providing the first test data and the first test state from the test repository to a second testing framework of the plurality of testing frameworks, receiving second test data and a second test state from the second testing framework, storing the second test data and the second test state in the test repository in association with the first test data, and providing access to the test repository upon completion of the multi-stage test or a set of all distinct tests on the application under test.

### TECHNICAL FIELD

The following relates generally to automated testing, such as in executing testing operations in a performance engineering environment.

### BACKGROUND

As the number of mobile users increases, so too does the importance of measuring performance metrics on mobile devices. For example, it is found that users expect applications (also referred to herein as “apps”) to load within a short amount of time, e.g., about two seconds. Because of this, some feel that native app load times should be as fast as possible. Additionally, poor app performance can impact an organization in other ways, for example, by increasing the number of technical service requests or calls, as well as negatively impacting ratings or rankings in application marketplaces (e.g., app stores), or more generally reviews or reputation. These negative impacts can also impact customer retention and uptake, particularly for younger generations who value their ability to perform many tasks remotely and with mobility.

Mobile performance testing typically measures key performance indicators (KPIs) from three perspectives, namely the end-user perspective, the network perspective, and the server perspective. The end-user perspective looks at installation, launch, transition, navigation, and uninstallation processes. The network perspective looks at network performance on different network types. The server perspective looks at transaction response times, throughput, bandwidth, and latency. This type of testing is performed in order to identify root causes of application performance bottlenecks to fix performance issues, lower the risk of deploying systems that do not meet business requirements, reduce hardware and software costs by improving overall system performance, and support individual, project-based testing and centers of excellence.

Testing applications, particularly those that provide both mobile and desktop/browser versions, and interact with multiple business units within an organization, typically require a number of different testing tools, monitoring tools, and diagnostic tools. Testing applications also may require multiple stages or routines that can become difficult to manage across an entire testing environment. There is currently a lack of an integrated testing framework that can manage these complexities. From these complexities can arise inefficiencies as well as a lack of uniformity across different test teams, making automation and streamlining more difficult. As a result, performance engineers are often required to execute on many tools and coordinate the implementation and results, which necessitates certain knowledge and skills, thus limiting the number of individuals able to perform the testing.

### BRIEF DESCRIPTION OF THE DRAWINGS

Embodiments will now be described with reference to the appended drawings wherein:

FIG. 1 is a schematic diagram of an example computing environment.

FIG. 2 is a schematic diagram of an example configuration of an automated testing system integrated with multiple application testing environments.

FIG. 3 is a block diagram of an example configuration of an application development environment.

FIG. 4 is a block diagram of an example configuration of an application testing environment.

FIG. 5 is a schematic diagram of an example of an automated testing system integrated with multiple application testing environments.

FIG. 6 is a schematic diagram of a mobile mirror utility and an execution monitor to provide user-centric testing visualization.

FIG. 7 is a block diagram of an example configuration of an automated testing system.

FIG. 8 is a block diagram of an example configuration of an enterprise system.

FIG. 9 is a block diagram of an example configuration of a test device used to test an application build in the application testing environment.

FIG. 10 is a block diagram of an example configuration of a client device used to interface with, for example, the automated testing system.

FIG. 11 is a flow diagram of an example of computer executable instructions for executing automated testing across multiple testing environments.

FIG. 12 is an example of a graphical user interface for accessing test results and end-to-end testing tools via an end-to-end testing dashboard.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

An integrated end-to-end testing framework with automation and enhanced monitoring tools is provided herein, including features and capabilities to increase testing efficiencies, to better integrate testing operations within and across technology frameworks, and to provide monitoring tools that focus on the user's perspective allowing non-technical resources to review and report on test results.

An automated testing system is provided, with an automation framework that provides a single integrated platform on which to test web, mobile, desktop, web services, and mainframe applications.

In order to enable the automation framework to share testing data and handover testing between multiple testing environments, a test repository is provided. This includes storing application programming interfaces (APIs) for framework-to-framework integration to permit app testing across different app environments, for example, across different lines of business within an organization. The automation framework passes test data and test states between testing environments using or along with providing this repository to implement a complete “end-to-end” capability, even across different areas within a larger digital ecosystem.

As used herein a “build” may refer to the process of creating an application program for a software release, by taking all the relevant source code files and compiling them and then creating build artifacts, such as binaries or executable program(s), etc. “Build data” may therefore refer to any files or other data associated with a build. The terms “build” and “build data” (or “build file”) may also be used interchangeably to commonly refer to a version or other manifestation of an application, or otherwise the code or program associated with an application that can be tested for performance related metrics.

It will be appreciated that while examples provided herein may be primarily directed to automated testing of mobile applications, the principles discussed herein equally apply to applications deployed on or otherwise used by other devices, such as desktop or laptop computers, e.g., to be run on a web browser or locally installed instance of an application. Similarly, the principles described herein can also be adapted to any performance engineering environment in which executable tasks are implemented, whether they include development, testing, implementation, production, quality assurance, etc.

Certain example systems and methods described herein are able to automate testing in a performance engineering environment. In one aspect, there is provided a device for automated testing. The device includes a processor, a communications module coupled to the processor, and a memory coupled to the processor. The memory stores computer executable instructions that when executed by the processor cause the processor to connect via the communications module to a plurality of testing frameworks, each testing framework configured to execute at least one operation in a distinct test or a portion of a multi-stage test on an application under test. The computer executable instructions, when executed, also cause the processor to receive first test data and a first test state from a first testing framework of the plurality of testing frameworks, via the communications module; store the first test data and the first test state in a test repository; and provide the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework. The computer executable instructions, when executed, also cause the processor to receive second test data and a second test state from the second testing framework, via the communications module; store the second test data and the second test state in the test repository in association with the first test data; and provide access to the test repository upon completion of the multi-stage test or a set of all distinct tests on the application under test.

In another aspect, there is provided a method of automated testing. The method is executed by a device having a communications module. The method includes connecting via the communications module to a plurality of testing frameworks, each testing framework configured to execute at least one operation in a distinct test or a portion of a multi-stage test on an application under test. The method also includes receiving first test data and a first test state from a first testing framework of the plurality of testing frameworks, via the communications module; storing the first test data and the first test state in a test repository; and providing the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework. The method also includes receiving second test data and a second test state from the second testing framework, via the communications module; storing the second test data and the second test state in the test repository in association with the first test data; and providing access to the test repository upon completion of the multi-stage test or a set of all distinct tests on the application under test.

In another aspect, there is provided a non-transitory computer readable medium for automated testing. The computer readable medium includes computer executable instructions for connecting via a communications module to a plurality of testing frameworks, each testing framework configured to execute at least one operation in a distinct test or a portion of a multi-stage test on an application under test. The computer readable medium also includes instructions for receiving first test data and a first test state from a first testing framework of the plurality of testing frameworks, via the communications module; storing the first test data and the first test state in a test repository; and providing the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework. The computer readable medium also includes instructions for receiving second test data and a second test state from the second testing framework, via the communications module; storing the second test data and the second test state in the test repository in association with the first test data; and providing access to the test repository upon completion of the multi-stage test or a set of all distinct tests on the application under test.

In certain example embodiments, the device can automatically transition the application under test through multiple distinct tests or the multi-stage test by passing the test data and test states across the plurality of testing frameworks according to at least one transition criterion, via the communications module.

In certain example embodiments, the device can process the first test data or the second test data to be interpretable by the other of the first and second testing frameworks.

In certain example embodiments, the first and second testing frameworks are each associated with different lines of business in an organization associated with the application under test. The application under test can include mobile and web browser versions requiring testing by each of the plurality of testing frameworks.

In certain example embodiments, the device can map objects in a user interface for the application under test to generate a database file to search for objects in testing the user interface, store the database file in an objects repository, and access the database file from the objects repository to execute at least one automated testing feature for at least one of the plurality of testing frameworks.

The at least one automated testing feature can include executing a self-healing operation using the database file in the repository. The at least one automated testing feature can also include automatically designing a test or test operation using the database file in the repository. The at least one automated testing feature can also include performing a visual verification operation to automatically detect and report differences found between screenshots and baselines for the application under test. The at least one automated testing feature can also include executing a smart object recognition process by navigating screens in the application to add to or revise the objects repository based on changes made to the application. The at least one automated testing feature can also include analyzing automation script failures from a feed of logs for failed scenarios and categorizing failures based on past occurrences.

In certain example embodiments, the device can monitor application testing by executing a test of the application under test on one or more devices, capturing images of screens during execution of the test, assembling an animated output using the images, and displaying the animated output during the test execution to visualize what is occurring on the one or more devices during the test execution.

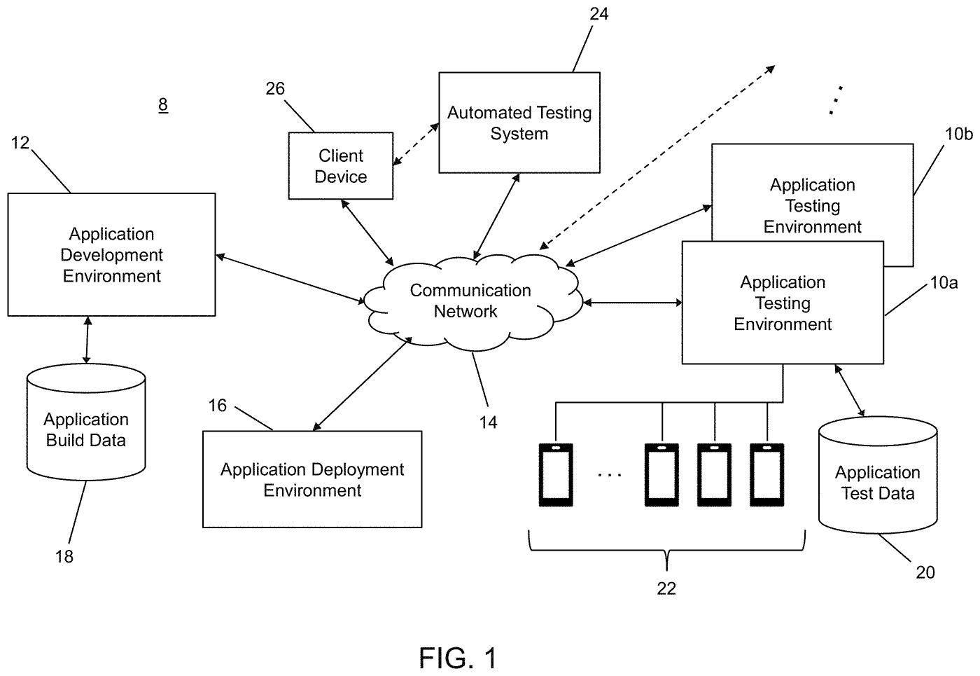

FIG. 1 illustrates an exemplary computing environment 8. In this example, the computing environment 8 may include multiple application testing environments 10 (10a, 10b, etc. shown by way of example), an application development environment 12, and a communications network 14 connecting one or more components of the computing environment 8. The computing environment 8 may also include or otherwise be connected to an application deployment environment 16, which provides a platform, service, or other entity responsible for posting or providing access to applications that are ready for use by client devices. The computing environment 8 may also include or otherwise be connected to an automated testing system 24, which provides an end-to-end testing framework and multiple tools and utilities to coordinate testing across the multiple testing frameworks associated with the multiple testing environments 10a, 10b, etc. The testing environments 10 can be associated with distinct portions or stages in a multi-stage test or can each be associated with a distinct test for an application under test that is created, monitored and controlled by a separate entity or unit within an organization. For example, different business units in an organization may have separate requirements and associated test(s) having an associated testing framework for those requirements and associated test(s).

The application development environment 12 includes or is otherwise coupled to one or more repositories or other data storage elements for storing application build data 18. The application build data 18 can include any computer code and related data and information for an application to be deployed, e.g., for testing, execution, or other uses. In this example, the application build data 18 can be provided via one or more repositories and include the data and code required to perform application testing on a device or simulator.

It can be appreciated that while FIG. 1 illustrates a number of test devices 22 that resemble a mobile communication device, such testing devices 22 can also include simulators, simulation devices or simulation processes, all of which may be collectively referred to herein as “test devices 22” for ease of illustration. The application testing environments 10 may include or otherwise have access to one or more repositories or other data storage elements for storing application test data 20, which includes any files, reports, information, results, metadata or other data associated with and/or generated during a test implemented within the application testing environment 10. It can be appreciated that while a single datastore is shown in FIG. 1 for storing the application test data 20, multiple separate datastores may be used by the multiple application testing environments 10a, 10b, etc.

Also shown in FIG. 1 is a client device 26, which may represent any electronic device that can be operated by a user to interact with or otherwise use the automated testing system 24 as herein described. The client device 26 can also represent any user or customer device that can obtain and use the applications being developed and tested within the computing environment 8 shown in FIG. 1.

The computing environment 8 may be part of an enterprise or other organization that both develops and tests applications. In such cases, the communication network 14 may not be required to provide connectivity between the application development environment 12, the automated testing system 24, and the application testing environment 10, wherein such connectivity is provided by an internal network. The application development environment 12, automated testing system 24, and application testing environment 10 may also be integrated into the same enterprise environment as subsets thereof. That is, the configuration shown in FIG. 1 is illustrative only.

Moreover, the computing environment 8 can include multiple enterprises or organizations, e.g., wherein separate organizations are configured to, and responsible for, implementing application testing and application development. For example, an organization may contract a third-party to develop an app for their organization but perform testing internally to meet proprietary or regulatory requirements. Similarly, an organization that develops an app may outsource the testing stages, particularly when testing is performed infrequently. The application deployment environment 16 may likewise be implemented in several different ways. For example, the deployment environment 16 may include an internal deployment channel for employee devices, may include a public marketplace such as an app store, or may include any other channel that can make the app available to clients, consumers or other users.

One example of the computing environment 8 may include a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc.

Test devices 22 can be, or be simulators for, client communication devices (e.g., client device 26) that would normally be associated with one or more users. Users may be referred to herein as customers, clients, correspondents, or other entities that interact with the enterprise or organization associated with the computing environment 8 via one or more apps. Such customer communication devices are not shown in FIG. 1 since such devices would typically be used outside of the computing environment 8 in which the development and testing occurs. Client device 26 shown in FIG. 1 may be a similar type of device as a customer communication device and is shown to illustrate a manner in which an individual can interact with the automated testing system 24. However, it may be noted that such customer communication devices and/or client device 26 may be connectable to the application deployment environment 16, e.g., to download newly developed apps, to update existing apps, etc.

In certain embodiments, a user may operate the customer communication devices such that customer device performs one or more processes consistent with what is being tested in the disclosed embodiments. For example, the user may use customer device to engage and interface with a mobile or web-based banking application which has been developed and tested within the computing environment 8 as herein described. In certain aspects, test devices 22, customer devices, and client device 26 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication networks such as the communication network 14 shown by way of example in FIG. 1.

Communication network 14 may include a telephone network, cellular, and/or data communication network to connect different types of electronic devices. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

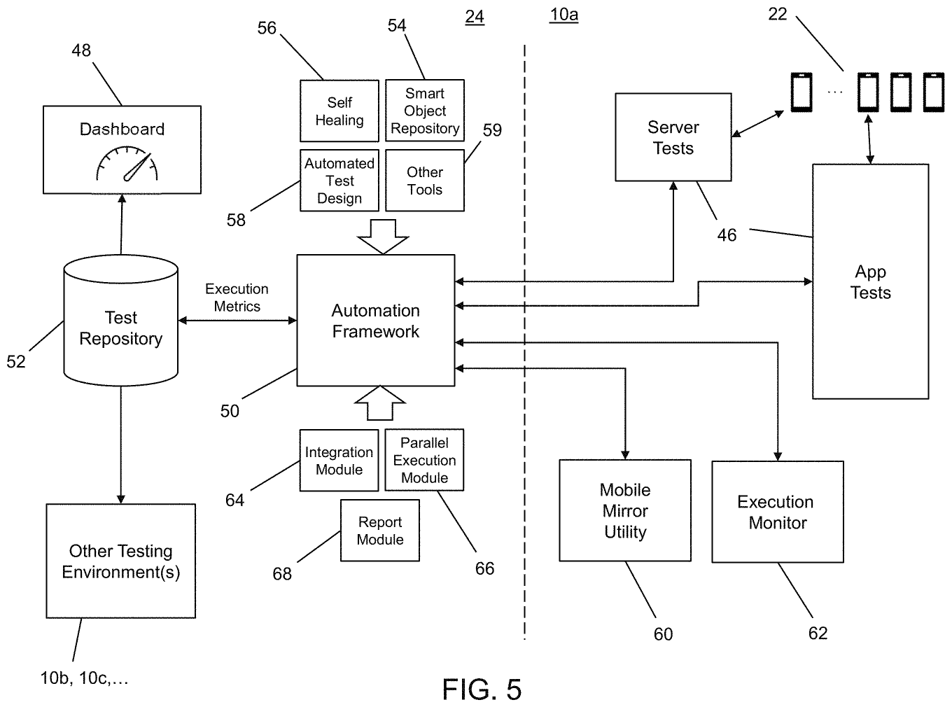

Referring back to FIG. 1, the computing environment 8 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the application development environment 12, automated testing system 24, and/or application testing environments 10. The cryptographic server may be used to protect data within the computing environment 8 (including the application build data 18 and/or application test data 20 and/or data stored in a test repository 52—see FIG. 5) by way of encryption for data protection, digital signatures or message digests for data integrity, and by using digital certificates to authenticate the identity of the users and entity devices with which the application development environment 12, automated testing system 24, and application testing environments 10 communicate to inhibit data breaches by adversaries. It can be appreciated that various cryptographic mechanisms and protocols can be chosen and implemented to suit the constraints and requirements of the particular deployment of the application development environment 12 and application testing environments 10 as is known in the art.

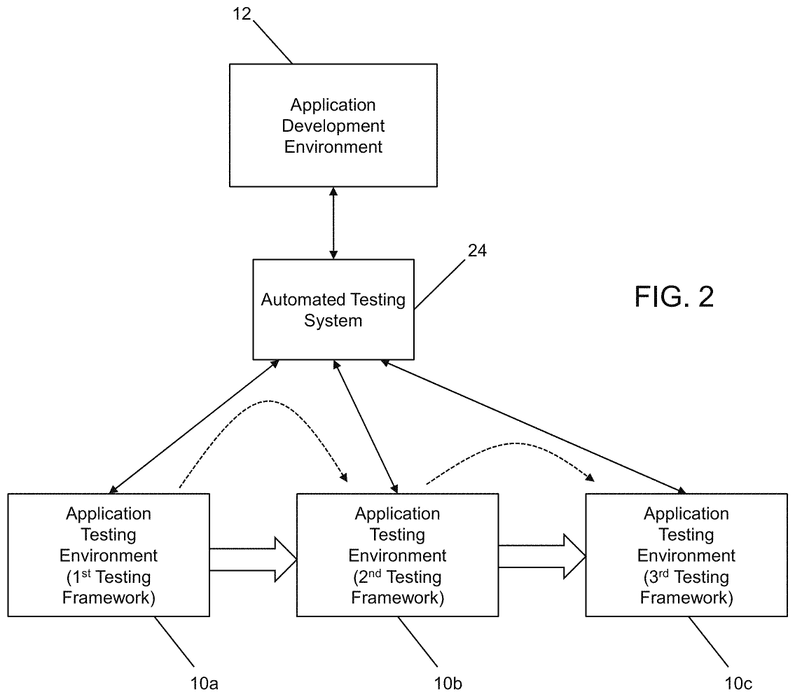

Referring now to FIG. 2, a schematic configuration for the automated testing system 24 being interfaced and integrated with multiple application testing environments 10 is shown. The configuration illustrated in FIG. 2 also illustrates the automated testing system 24 being interfaced and integrated with the application development environment 12, e.g., to provide access to test result data shared across the testing frameworks in conducting end-to-end testing across an enterprise or organization. In this example, three applications testing environments 10a, 10b, 10c are shown for illustrative purposes, however, there is no limit on the number of distinct application testing environments 10 that can be integrated together via the automated testing system 24.

Each application testing environment 10 in this example has its own testing framework, i.e., a first testing framework, a second testing framework and a third testing framework in this example. The testing frameworks can be the same, similar or dissimilar to each other, but each are provided, maintained and/or controlled within a particular application testing environment 10 such that a testing stage or separate test or tests is/are performed on an application under test. For example, an enterprise application may have multiple modules that are each tested separately by different business units, thus creating separate and multiple application testing environments 10 and corresponding testing frameworks.

The automated testing system 24 enables test data and test states to be accessible across multiple testing frameworks such that tests can proceed from framework to framework as illustrated in FIG. 2 or otherwise be combined or concatenated together centrally when distinct tests are performed. In this way, testing can pass from testing environment 10 to testing environment 10 in a seamless manner. While FIG. 2 illustrates a linear progression between testing environments 10a, 10b, 10c, this is purely illustrative of one example and it can be appreciated that more complex workflows between tests can also be implemented using the automated testing system 24.

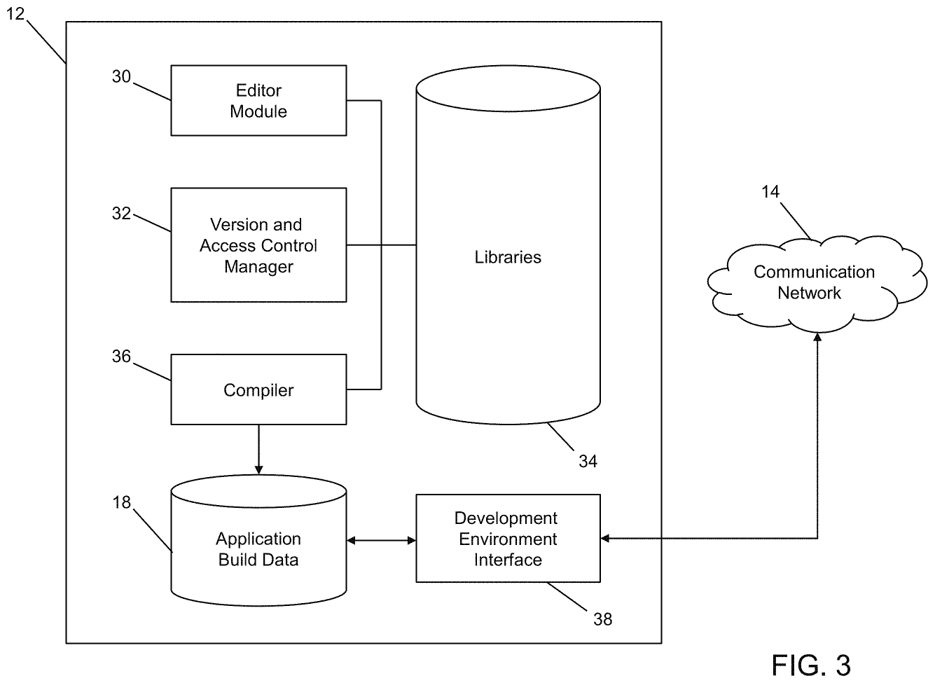

In FIG. 3, an example configuration of the application development environment 12 is shown. It can be appreciated that the configuration shown in FIG. 3 has been simplified for ease of illustration. In certain example embodiments, the application development environment 12 may include an editor module 30, a version and access control manager 32, one or more libraries 34, and a compiler 36, which would be typical components utilized in application development. In this example, the application development environment 12 also includes the application build data 18, which, while shown within the environment 12, may also be a separate entity (e.g., repository) used to store and provide access to the stored build files. The application development environment 12 also includes or is provided with (e.g., via an API), a development environment interface 38. The development environment interface 38 provides communication and data transfer capabilities between the application development environment 12 and the application testing environment(s) 10 from the perspective of the application development environment 12. As shown in FIG. 3, the development environment interface 38 can connect to the communication network 14 to send/receive data and communications to/from the application testing environment(s) 10, including instructions or commands initiated by/from the automated testing system 24, as discussed further below.

The editor module 30 can be used by a developer/programmer to create and edit program code associated with an application being developed. This can include interacting with the version and access control manager 32 to control access to current build files and libraries 34 while honoring permissions and version controls. The compiler 36 may then be used to compile an application build file and other data to be stored with the application build data 18. It can be appreciated that a typical application or software development environment 12 may include other functionality, modules, and systems, details of which are omitted for brevity and ease of illustration. It can also be appreciated that the application development environment 12 may include modules, accounts, and access controls for enabling multiple developers to participate in developing an application, and modules for enabling an application to be developed for multiple platforms. For example, a mobile application may be developed by multiple teams, each team potentially having multiple programmers. Also, each team may be responsible for developing the application on a different platform, such as Apple iOS or Google Android for mobile versions, and Google Chrome or Microsoft Edge for web browser versions. Similarly, applications may be developed for deployment on different device types, even with the same underlying operating system.

By having build files stored for all of the various operating systems, device types, and versions that are currently compatible and being used, and providing access via the development environment interface 38, the application testing environments 10 can automatically obtain and deploy the latest builds to perform application testing in different scenarios and using the multiple different testing frameworks illustrated in FIG. 2. Such scenarios can include not only different device types, operating systems, and versions, but also the same build under different operating conditions.

While not shown in FIG. 3 for clarity of illustration, in example embodiments, the application development environment 12 may be implemented using one or more computing devices such as terminals, servers, and/or databases, having one or more processors, communications modules, and database interfaces. Such communications modules may include the development environment interface 38, which enables the application development environment 12 to communicate with one or more other components of the computing environment 8, such as the application testing environment(s) 10, via a bus or other communication network; such as the communication network 14. While not delineated in FIG. 3, the application development environment 12 (and any of its devices, servers, databases, etc.) includes at least one memory or memory device that can include a tangible and non-transitory computer-readable medium having stored therein computer programs, sets of instructions, code, or data to be executed by the one or more processors. FIG. 3 illustrates examples of modules, tools and engines stored in memory within the application development environment 12. R can be appreciated that any of the modules, tools, and engines shown in FIG. 3 may also be hosted externally and be available to the application development environment 12, e.g., via communications modules such as the development environment interface 38.

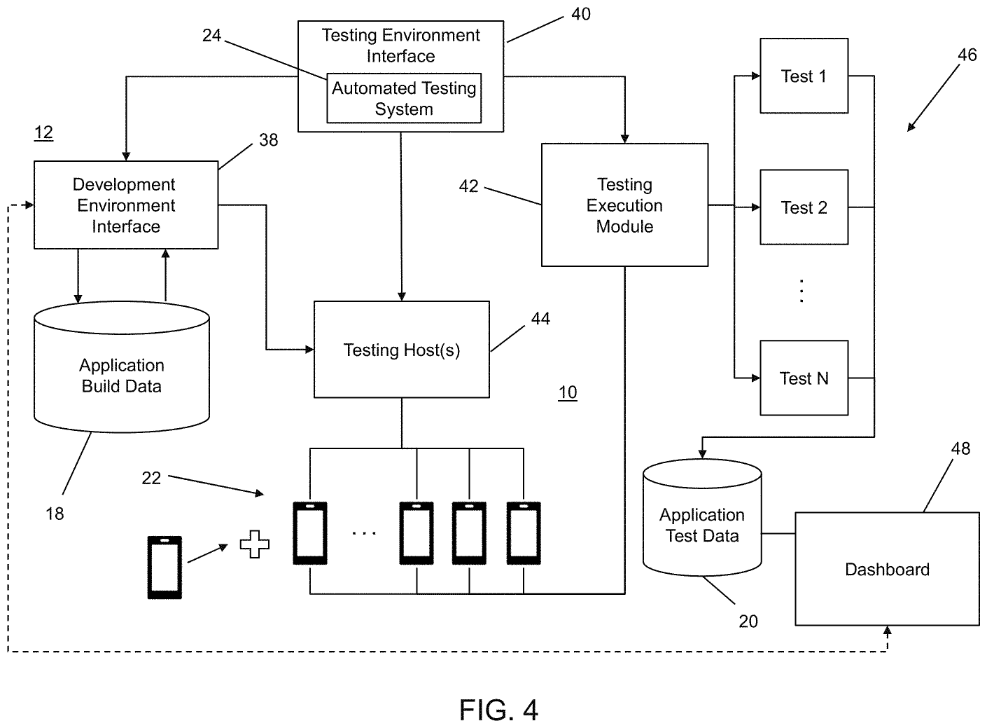

Turning now to FIG. 4, an example configuration of an application testing environment 10 is shown. It can be appreciated that other application testing environments 10 in the computing environment may be similar or may have different configurations thus providing different testing frameworks. As such, the example shown in FIG. 4 is illustrative of one particular testing framework. The application testing environment 10 and testing framework in FIG. 4 includes a testing environment interface 40, which is coupled to the development environment interface 38 in the application development environment 12, a testing execution module 42, and one or more testing hosts 44. The testing environment interface 40 can provide a UI for personnel or administrators in the application testing environment 10 to coordinate an automated build management process and to initiate or manage a test execution process as herein described. The testing environment interface 40 can also include, as illustrated in FIG. 4, the automated testing system 24 (or an API into the system 24) to provide such UI for personnel or administrators, e.g., via a chat UI as described in greater detail below.

The testing environment interface 40 can provide a platform on which the automated testing system 24 (or an instance thereof) can operate to instruct the development environment interface 38, e.g., by sending a message or command via the communication network 14, to access the application build data 18 to obtain the latest application build(s) based on the number and types of devices being tested by the testing host(s) 44. The latest application builds are then returned to the application testing environment(s) 10 by the development environment interface 38 to execute an automated build retrieval operation. This process can be implemented to enable each application testing environment 10a, 10b, 10c, etc. to obtain the latest build in order to perform a distinct test or a stage in a multi-stage test. As shown in FIG. 4, the application build data 18 can be sent directly to the testing host(s) 44 and thus the testing host(s) 44 can also be coupled to the communication network 14. It can be appreciated that the application build data 18 can also be provided to the testing host(s) 44 via the testing environment interface 40, e.g., through messages handled by the automated testing system 24 via an application or dashboard 48 (see also FIG. 5). The host(s) 44 in this example have access to a number of test devices 22 which, as discussed above, can be actual devices or simulators for certain devices. The testing host(s) 44 are also scalable, allowing for additional test devices 22 to be incorporated into the application testing environment 10. For example, a new test device 22 may be added when a new device type is released and will be capable of using the application being tested. Upon installation, the application on each test device 22 can be configured to point to the appropriate environment under test and other settings can be selected/deselected.

The test devices 22 are also coupled to the testing execution module 42 to allow the testing execution module 42 to coordinate tests 46 to evaluate metrics, for example, by executing tests for application traffic monitoring, determining UI response times, examining device logs, and determining resource utilization metrics (with Test 1, Test 2, . . . , Test N; shown in FIG. 4 for illustrative purposes). The tests 46 can generate data logs, reports and other outputs, stored as application test data 20, which can be made available to various entities or components, such as the dashboard 48. It can be appreciated that, as discussed further below, the dashboard 48 can be accessible to the automated testing system 24 as well as the application testing environments 10 to view, analyze and process the application test data 20 through multiple endpoints. The framework shown in FIG. 4 enables the application testing environment 10 to download the latest builds from the respective repositories for the respective device/OS platform(s) and run a UI flow on all test devices 22 to configure the environment, disable system pop-ups, and set feature flags. In this way, the framework can automate the build download and installation process. The framework shown in FIG. 4 can also enable tests 46 to be initiated, status updates for such tests 46 to be obtained, and other information gathered concerning the tests 46 and/or test data 20, through inputs interpreted by a chat UI of the automated testing system 24.

It can be appreciated that while the testing environment interface 40, the testing host(s) 44, and the testing execution module 42 are shown as separate modules in FIG. 4, such modules may be combined in other configurations and thus the delineations shown in FIG. 4 are for illustrative purposes.

Turning now to FIG. 5, a schematic configuration is shown of an example integration of the automated testing system 24 and an application testing environment 10a, with further integration with other testing environments 10b, 10c, etc. As shown in FIG. 5, an automation framework 50 can be provided to centrally integrate testing for web, mobile, desktop, web services and main frame applications, as well as applications that are used in multiple ones of these formats and require testing in different testing frameworks. In the example shown in FIG. 5, a first testing framework is shown for a first application testing environment 10a. This testing framework includes, by way of example, one more server tests and one or more application tests 46 that can be implemented by various tools such as those that can perform device automation, browser automation, visual verification (e.g., using AI), accessibility scans, host automation, API testing, etc.

The automation framework 50 can be used to automate the execution of these tests 46 as well as obtain test results, e.g., test data and test states that can be stored in a test repository 52. This allows the automation framework 50 to pass test data and test states to other testing environments 10b, 10c, etc. or otherwise enable such other environments 10b, 10c to access the test repository 52. By being integrated with and between the multiple application testing environments 10a, 10b, 10c, etc., the automated testing system 24 (and automation framework 50) can provide complete end-to-end testing of an application under test. That is, multiple distinct tests or multiple stages of a same test that are implemented by separate testing frameworks can be coordinated and framework-to-framework integration provided.

The dashboard 48 is also shown in FIG. 5, which can be used to monitor and/or control the automation framework 50, perform analytics, etc. That is, the dashboard 48 can provide a visual portal into the automated application system 24. Similarly, the automation framework 50 communicates with a mobile mirror utility 60 and execution monitor 62 that in this configuration are deployed in the application testing environment 10a but could also reside and be controlled from within the automated testing system 24.

The automation framework 50 can also integrate several artificial intelligence (AI) tools, some of which are illustrated in the configuration shown in FIG. 5. Smart object recognition can be implemented using an intelligent app crawler that navigates various screens in the application and understands the objects (elements) to interact with and automatically create a smart object repository 54. This repository can be automatically updated, every time a new build is available. The smart object repository 54 facilitates the other tools, such as the self-healing 56 and automated test design 58 features described below, by mapping the objects in the application. For example, in a browser, buttons and text box locations can be mapped using a document object model (DOM). The smart object repository 54 provides an ability to traverse the DOM in a specified way and call features of objects. This effectively provides a flat file or database that includes where objects are and what they do. The self-healing module 56 is an AI tool that can be used to “heal” broken automated test cases by updating the controls (e.g., buttons), its properties (e.g., identifier (ID)), data and infrastructure failures at runtime to make automated test execution more resilient. The automated test design module 58 can provide a capability to read, understand and interpret the application requirements and provide a list of test conditions or intents, required to be tested.

Various other AI tools 59 can also be utilized by the automation framework 50. For example, visual verification can be implemented using an AI-powered computer-vision algorithm to detect and report any difference found between screenshots and baselines. By emulating the human eye and brain, the algorithms can be used to only report differences that are visible to the users (e.g., with no calibration, training, tweaking or thresholds required). Another example of the other tools 59 can include a smart failure analysis tool that implements a bot to assist in the analysis of automation script failures. Such an analysis tool can be configured to takes the feed of various logs (e.g., automation logs, application logs, error messages in screenshots, network logs, etc.) for the failed scenarios, categorize the failures based on past learning, and execute or trigger an appropriate action according to the category of failure.

Various other integrated testing features can be deployed with or on top of the automation framework 50. For example, as shown in FIG. 5, a parallel execution module 66 can be used for on demand support for parallel execution, reducing the overall testing time. A report module 68 can also be used, e.g., for providing HTML reports; and an integration module 64 can be used to integrate the automated testing system 24 with an application lifecycle management (ALM) system (not shown). Other integrated testing features can include accessibility testing for out of the box support to perform accessibility code scans and to provide violations highlighted on the screen integrated with the dashboard 48. Another example is a quality assurance (QA) dashboard to provide in-house support to update test matrices in real time, integrated with a QA dashboard.

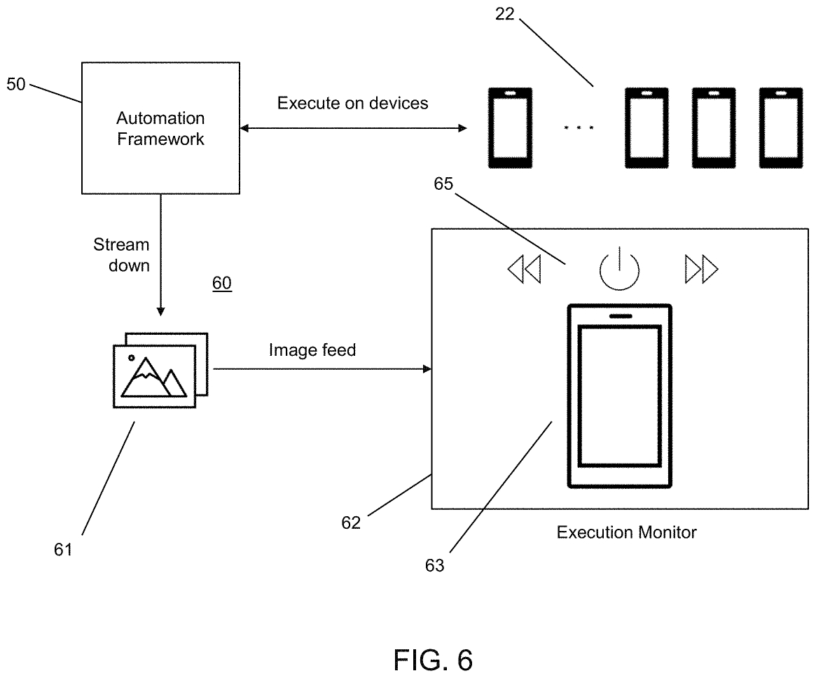

The mobile mirror utility 60 and execution monitor 62 are examples of user-centric monitoring features for monitoring the testing process(es). Referring to FIG. 6, a schematic diagram illustrating operation of the mobile mirror utility 60 and execution monitor 62, is shown. The execution monitor 62 allows users to see the real time execution status, and can provide “one click” execution of the required scenarios for testing. That is, the execution monitor 62 can provide a tool for users to see the status of a test execution “on the fly”. This capability can also be provided across testing frameworks. The mobile mirror utility 60 is a custom solution for mirroring remote devices (e.g., iOS and Android) on the computer screen. In addition to execution, the framework streams down the screen image 61 at regular intervals from the automation framework 50 as shown in FIG. 6. The image 61 is presented by the mobile mirror utility 60 in an animated fashion on the execution monitor 62, which provides an animated output 63 and one or more controls 65 to execute various scenarios.

An advantage of the mobile mirror utility 60 is that normally the tester is unable to observe the execution of the test from the perspective that the user would see. The mobile mirror utility 60 provides visibility into what is happing on the device 22 as the test mimics the functionality by providing a “listener” in the device 22 and obtaining a current state of the associated driver to provide screens in an automated fashion as shown in FIG. 6. This user-focused approach allows the tester to comprehend what is going on.

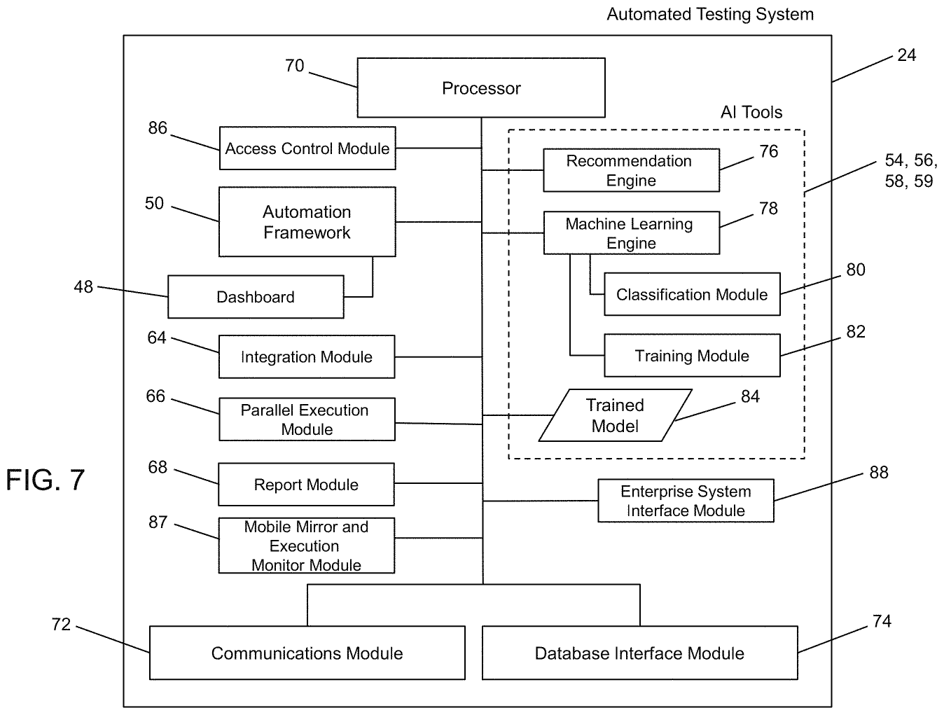

In FIG. 7, an example configuration of the automated testing system 24 is shown. In certain embodiments, the automated testing system 24 may include one or more processors 70, a communications module 72, and a database interface module 74 for interfacing with the datastores for the build data 18, test data 20, and test repository 52, to retrieve, modify, and store (e.g., add) data. Communications module 72 enables the automated testing system 24 to communicate with one or more other components of the computing environment 8, such as client device 26 (or one of its components), via a bus or other communication network, such as the communication network 14. While not delineated in FIG. 7, the automated testing system 24 includes at least one memory or memory device that can include a tangible and non-transitory computer-readable medium having stored therein computer programs, sets of instructions, code, or data to be executed by processor 70. FIG. 7 illustrates examples of modules, tools and engines stored in memory on the automated testing system 24 and executed by the processor 70. It can be appreciated that any of the modules, tools, and engines shown in FIG. 7 may also be hosted externally and be available, to the automated testing system 24, e.g., via the communications module 72. In the example embodiment shown in FIG. 7, the automated testing system 24 includes a suite or set of AI tools, which can include, for example, those tools denoted by numerals 54, 56, 58 and 59. The AI tools 54, 56, 58, 59 include or otherwise have access to a recommendation engine 76, a machine learning engine 78, a classification module 80, a training module 82, and at least one trained model 84. The automated testing system 24 also includes an access control module 86 and the automation framework 50. The automation framework 50 includes or has access to the dashboard 48 as also shown in FIG. 5. The automated testing system 24 also includes the integration module 64, the parallel execution module 66, the report module 68, a mobile mirror and execution monitor module 87, and an enterprise system interface module 88.

The recommendation engine 76 is used by the AI tools 54, 56, 58, 59 of the automated testing system 24 to generate one or more recommendations for the automated testing system 24 and/or a client device 26 that is/are related to testing automation, such as by determining or using smart objects, automating test design(s), and self-healing of application features. It may be noted that a recommendation as used herein may refer to a prediction, suggestion, inference, association or other recommended identifier that can be used to generate a suggestion, notification, command, instruction or other data that can be viewed, used or consumed by the automated testing system 24, the testing environment interface 40 and/or the client devices 26 interacting with same. The recommendation engine 76 can access application test data 20, application build data 18 other data stored by in the test repository 52 (e.g., test states) or other data and information, e.g., analytics data handled by the dashboard 48, and apply one or more inference processes to generate the recommendation(s). The recommendation engine 76 may utilize or otherwise interface with the machine learning engine 78 to both classify data currently being analyzed to generate a suggestion or recommendation, and to train classifiers using data that is continually being processed and accumulated by the automated testing system 24. That is, the recommendation engine 76 can learn testing outcomes, testing failures (e.g., for self-healing) or other test-related metrics and revise and refine classifications, rules or other analytics-related parameters over time. For example, the trained model 84 can be updated and refined using the training module 82 as client devices 26 interact with the automated testing system 24 during various interactions to improve the AI/machine learning (ML) parameters and understanding of how testing is implemented, monitored, and fixed.

The machine learning engine 78 may also perform operations that classify the test and application data in accordance with corresponding classifications parameters, e.g., based on an application of one or more machine learning algorithms to the data or groups of the data (also referred to herein as “app content”, “test or testing content”, “application build requests” or “test results content”). The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the testing-related content or content being analyzed, the recommendation engine 76 may further process each element of the content to identify, and extract, a value characterizing the corresponding one of the classification parameters, e.g., based on an application of one or more additional machine learning algorithms to each of the elements of the chat-related content. By way of example, the additional machine learning algorithms may include, but are not limited to, an adaptive natural language processing (NLP) algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. Classification parameters may be stored and maintained using the classification module 80, and training data may be stored and maintained using the training module 82.

The trained model 84 may also be created, stored, refined, updated, re-trained, and referenced by the automated testing system 24 (e.g., by way of the AI tools 54, 55, 58, 59) to determine associations between testing-related messages or commands, and suitable responses or actions, and/or content related thereto. Such associations can be used to generate recommendations or suggestions for improving testing procedures or application features being tested.

In some instances, classification data stored in the classification module 80 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between testing objectives and testing outcomes, and certain potential actions. For example, the smart object repository 54 can be used to determine a feature that can be subjected to a self-healing 56 operation.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 78 may perform operations that classify each of the discrete elements of testing-related content as a corresponding one of the classification parameters, e.g., as obtained from classification data stored by the classification module 80.

The outputs of the machine learning algorithms or processes may then be used by the recommendation engine 76 to generate one or more suggested recommendations, instructions, commands, notifications, rules, or other instructional or observational elements that can be presented to the AI tools 54, 56, 58, 59, to the automation framework 50, dashboard 48 or other module of the automated testing system 24.

Referring again to FIG. 7, the access control module 86 may be used to apply a hierarchy of permission levels or otherwise apply predetermined criteria to determine what testing data or other client/user, financial or transactional data can be shared with which entity in the computing environment 8. For example, the automated testing system 24 may have been granted access to certain sensitive user profile data for a user, which is associated with a certain client device 26 in the computing environment 8. Similarly, certain client data may include potentially sensitive information such as age, date of birth, or nationality, which may not necessarily be needed by the automated testing system 24 to execute certain actions (e.g., to more accurately determine the spoken language or conversational style of that user). As such, the access control module 86 can be used to control the sharing of certain client data or chat data, a permission or preference, or any other restriction imposed by the computing environment 8 or application in which the automated testing system 24 is used.

The automated testing system 24 in this example also includes the automation framework 50 described above, which can also provide access to the dashboard 48. The integration module 64, parallel execution module 66, and report module 68 are also shown in FIG. 7 which, as described above, can be used to integrate the automate testing framework 24 with the application testing environments 10 while providing the ability to operate testing in parallel within different frameworks as well as between testing frameworks and obtain data and information to generate reports for the dashboard 48 and/or to be shared between testing frameworks. Similarly, the automated testing system 24 can include a mobile mirror and execution monitor module 87 to enable the automation framework 50 and other modules shown in FIG. 7 to utilize and obtain data from the mobile mirror utility 60 and execution monitor 62.

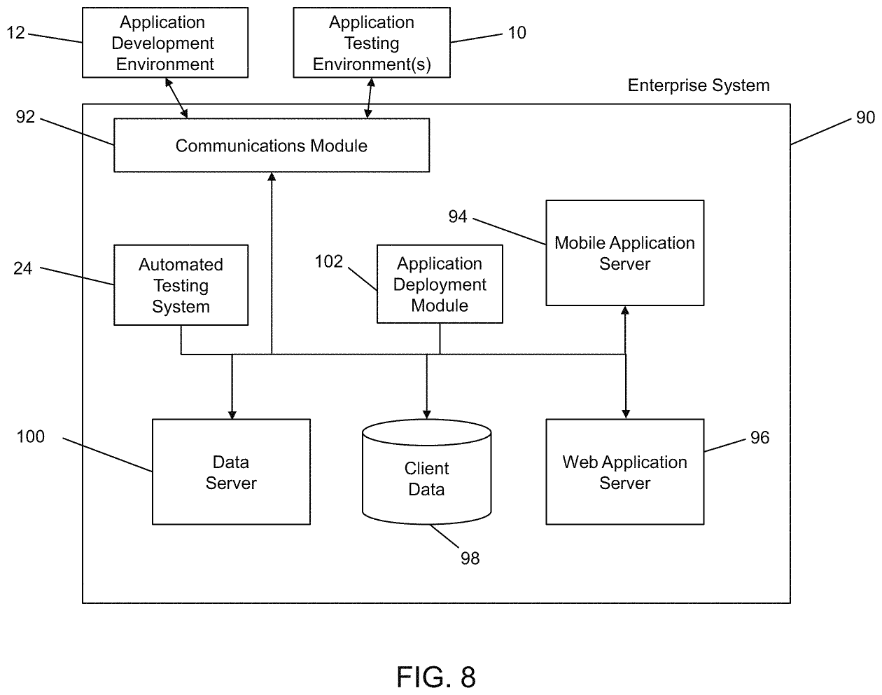

The automated testing system 24 may also include the enterprise system interface module 88 to provide a graphical user interface (GUI) or API connectivity to communicate with an enterprise system 90 (see FIG. 8) to obtain client data 98 for a certain user interacting with the automated testing system 24 or to access or communicate with other applications, platforms and personnel within the enterprise. It can be appreciated that the enterprise system interface module 88 may also provide a web browser-based interface, an application or “app” interface, a machine language interface, etc.

As illustrated in FIG. 7, the automation framework 50 as well as the automated testing system 24 can be considered one or more devices having a processor 70, memory and a communications module 72 configured to work with, or as part of, the computing environment 8, to perform the operations described herein. It can be appreciated that the various elements of the automated testing system 24 are shown delineated as such in FIG. 7 for illustrative purposes and clarity of description and could be provided using other configurations and distribution of functionality and responsibilities.

In FIG. 8, an example configuration of an enterprise system 90 is shown. The enterprise system 90 includes a communications module 92 that enables the enterprise system 90 to communicate with one or more other components of the computing environment 8, such as the application testing environment(s) 10, application development environment 12, or automated testing system 24, via a bus or other communication network, such as the communication network 14. While not delineated in FIG. 8, the enterprise system 90 includes at least one memory or memory device that can include a tangible and non-transitory computer-readable, medium having stored therein computer programs, sets of instructions, code, or data to be executed by one or more processors (not shown for clarity of illustration). FIG. 8 illustrates examples of servers and datastores/databases operable within the enterprise system 90. It can be appreciated that any of the components shown in FIG. 8 may also be hosted externally and be available to the enterprise system 90, e.g., via the communications module 92. In the example embodiment shown in FIG. 8, the enterprise system 90 includes one or more servers to provide access to client data 98, e.g., to assist in determining application development or testing improvements based on, for example, user profile data. Exemplary servers include a mobile application server 94, a web application server 96 and a data server 100. Although not shown in FIG. 8, the enterprise system 90 may also include a cryptographic server for performing cryptographic operations and providing cryptographic services. The cryptographic server can also be configured to communicate and operate with a cryptographic infrastructure. The enterprise system 90 may also include one or more data storage elements for storing and providing data for use in such services, such as data storage for storing client data 98.

Mobile application server 94 supports interactions with a mobile application installed on client device 26 (which may be similar or the same as a test device 22). Mobile application server 94 can access other resources of the enterprise system 90 to carry out requests made by, and to provide content and data to, a mobile application on client device 26. In certain example embodiments, mobile application server 94 supports a mobile banking application to provide payments from one or more accounts of user, among other things.

Web application server 96 supports interactions using a website accessed by a web browser application running on the client device. It can be appreciated that the mobile application server 94 and the web application server 96 can provide different front ends for the same application, that is, the mobile (app) and web (browser) versions of the same application. For example, the enterprise system 90 may provide a banking application that be accessed via a smartphone or tablet app while also being accessible via a browser on any browser-enabled device.

The client data 98 can include, in an example embodiment, financial data that is associated with users of the client devices (e.g., customers of the financial institution). The financial data may include any data related to or derived from financial values or metrics associated with customers of a financial institution system (i.e., the enterprise system 60 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices 26.

An application deployment module 102 is also shown in the example configuration of FIG. 8 to illustrate that the enterprise system 90 can provide its own mechanism to deploy the developed and tested applications onto client devices 26 within the enterprise. It can be appreciated that the application deployment module 102 can be utilized in conjunction with a third-party deployment environment such as an app store to have tested applications deployed to employees and customers/clients.

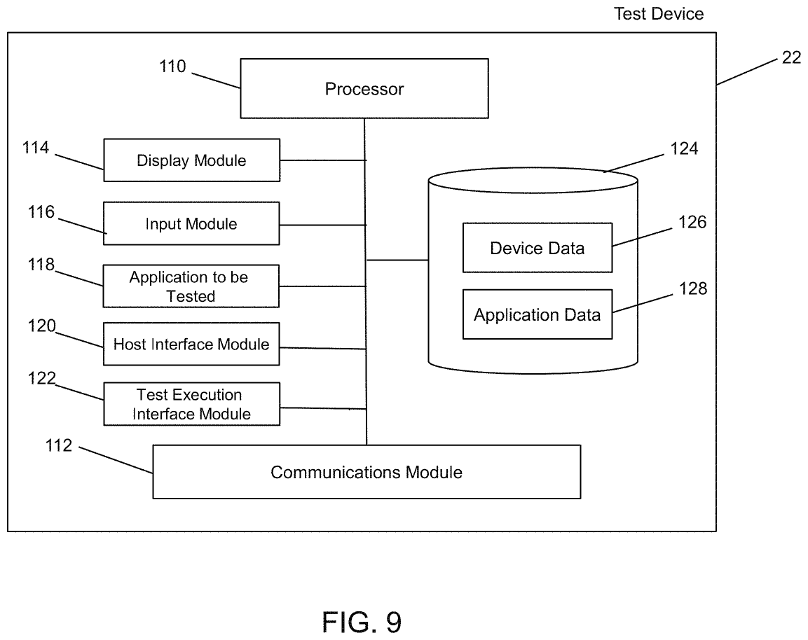

In FIG. 9, an example configuration of a test device 22 is shown. It can be appreciated that the test device 22 shown in FIG. 9 can correspond to an actual device or represent a simulation of such a device 22. In certain embodiments, the client device 22 may include one or more processors 110, a communications module 112, and a data store 124 storing device data 126 and application data 128. Communications module 112 enables the test device 22 to communicate with one or more other components of the computing environment 8 via a bus or other communication network, such as the communication network 14. While not delineated in FIG. 9, the client device 22 includes at least one memory or memory device that can include a tangible and non-transitory computer-readable medium having stored therein computer programs, sets of instructions, code, or data to be executed by processor 110. FIG. 9 illustrates examples of modules and applications stored in memory on the test device 22 and operated by the processor 110. It can be appreciated that any of the modules and applications shown in FIG. 7 may also be hosted externally and be available to the test device 22, e.g., via the communications module 112.

In the example embodiment shown in FIG. 9, the test device 22 includes a display module 114 for rendering GUIs and other visual outputs on a display device such as a display screen, and an input module 116 for processing user or other inputs received at the test device 22, e.g., via a touchscreen, input button, transceiver, microphone, keyboard, etc. The test device 22 may also include an application 118 to be tested that includes the latest application build data 18 to be tested using the test device 22, e.g., by executing tests. The test device 22 may include a host interface module 120 to enable the test device 22 to interface with a testing host for loading an application build. The test device 22 in this example embodiment also includes a test execution interface module 122 for interfacing the application 118 with the testing execution module. The data store 124 may be used to store device data 126, such as, but not limited to, an IP address or a MAC address that uniquely identifies test device 22. The data store 124 may also be used to store application data 128, such as, but not limited to, login credentials, user preferences, cryptographic data (e.g., cryptographic keys), etc.

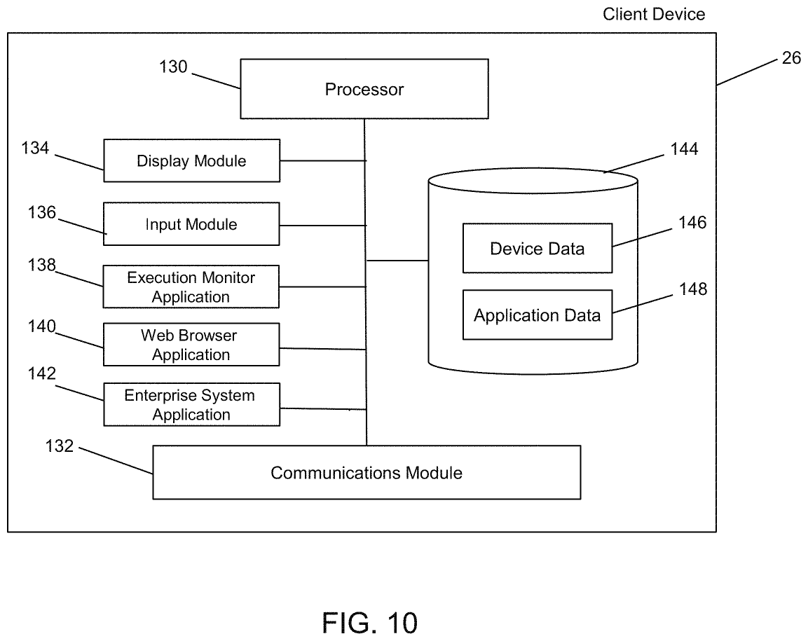

In FIG. 10, an example configuration of the client device 26 is shown. In certain embodiments, the client device 26 may include one or more processors 130, a communications module 132, and a data store 144 storing device data 146 and application data 148. Communications module 132 enables the client device 26 to communicate with one or more other components of the computing environment 8, such as the automated testing system 24, via a bus or other communication network, such as the communication network 14. While not delineated in FIG. 10, the client device 26 includes at least one memory or memory device that can include a tangible and non-transitory computer-readable medium having stored therein computer programs, sets of instructions, code, or data to be executed by processor 130. FIG. 10 illustrates examples of modules and applications stored in memory on the client device 26 and operated by the processor 130. It can be appreciated that any of the modules and applications shown in FIG. 10 may also be hosted externally and be available, to the client device 26, e.g., via the communications module 132.

In the example embodiment shown in FIG. 10, the client device 26 includes a display module 134 for rendering GUIs and other visual outputs on a display device such as a display screen, and an input module 136 for processing user or other inputs received at the client device 26, e.g., via a touchscreen, input button, transceiver, microphone, keyboard, etc. The client device 26 may also include an execution monitor application 138, which may take the form of a customized app, plug-in, widget, or software component provided by the automated testing system 24 for use by the client device 26 to use the mobile mirror utility 60 and/or execution monitor 62. Similarly, the client device 26 may include an enterprise system application 142 provided by the enterprise system 90. The client device 26 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 26 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 3 to 10 for ease of illustration and various other components would be provided and utilized by the application testing environments 10, application development environment 12, automated testing system 24, test device 22, enterprise system 90, and client device 26 as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the application testing environment(s) 10, application development environment 12, automated testing system 24, enterprise system 90, client device 26, or test device 22, or accessible or connectable thereto. Any application or module herein described may be implemented using computer readable/executable instructions that may be stored or otherwise held by such computer readable media.

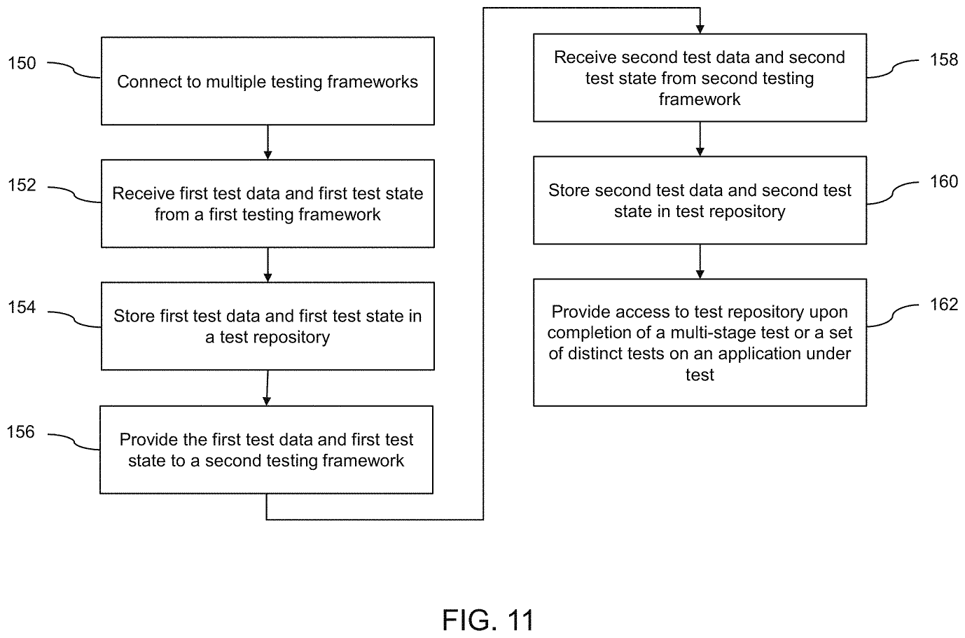

Referring to FIG. 11, an example embodiment of computer executable instructions for automated testing in a performance engineering environment, such as an application testing or development environments 10, 12, or another computing environment 8, is shown. At block 150, the automated testing system 24, e.g., using the automation framework 50, connects to multiple testing frameworks, e.g., within the application testing environments 10a, 10b, 10c, etc. Each of these testing frameworks is considered to be configured to execute at least one operation in a distinct test or a portion or state of a multi-stage test on an application under test, e.g., the enterprise system application 142 such as a mobile banking application. At block 152, the automation framework 50 receives first test data and a first test state from a first one of the testing frameworks, e.g., from application testing environment 10a as illustrated in FIG. 5. The test data can include any test results, test metrics, messages, notifications, or other data related to or associated with the test or portion of the test being conducted by the first testing framework. For example, the first test data can include test results of a series of tests performed on the application under test by a particular business unit having their own specific test objectives and requirements. The first test state can include an identifier or information indicative of the test status, test stage, which portion(s) of the application were tested, what else need to be tested, etc. At block 154, the first test data and the first test state are stored in the test repository 52.

The stored test data and test state are interpretable by other testing frameworks to enable a corresponding distinct test or portion of a multi-stage test on the application under test to be executed by the other application testing frameworks. In this way, duplicate testing operations can be avoided, and failures already detected can be observed and taken into account within the other testing framework. This can include processing the first test data and/or first test state to be interpretable within other frameworks, e.g., by normalizing data, converting data, etc.

At block 156, the automation framework 50 can provide the first test data and first test state to a second of the testing frameworks, e.g., by sending or providing access to the first test data and first test state to another of the application testing environments 10. This can be done in the context of automatically transitioning the application under test through multiple distinct tests or the multi-stage test by passing the test data and test states across the multiple testing frameworks according to at least one transition criterion. For example, testing may need to pass between frameworks in a particular order and/or require review or approvals between transitions.

At block 158, the automation framework 50 receives second test data and a second test state from a second testing framework, which are stored in the test repository 52 at block 160. This effectively “stiches” or concatenates the testing data from multiple application testing environments 10 in the test repository 52 to provide true end-to-end testing, monitoring, control and visualization, e.g., using the dashboard 48. In this way, at block 162, the automation framework 50 can provide access to the test repository 52 at least upon completion of the multi-stage test or a set of distinct tests on the application under test. That is, the test repository 52 can be accessed to provide the necessary data (e.g., results) and test states to provide an overall end-to-end view of the testing being performed on a particular build of the application, which can span across multiple business units or other departments or phases within an enterprise or other organization.

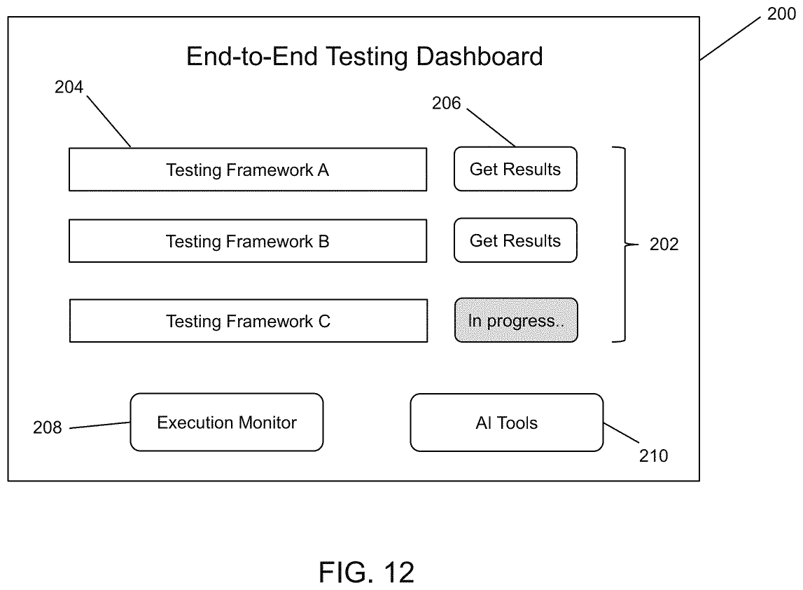

Turning now to FIG. 12, a screen shot 200 of a visual output from the dashboard 48, is shown. In this example, the dashboard screen 200 provides an end-to-end testing dashboard to monitor and control the implementation of tests performed across multiple testing frameworks. A list 202 of the applicable testing frameworks is displayed, with each entry in the list 202 including a testing environment or framework identifier 204 and an operation button 206. In this example, the operation buttons 206 can change based on a test state. For Framework A and Framework B, the tests or stages of a test are completed and the operation buttons 206 enable a user to click through to get results. For Framework C in this scenario the testing within that framework is in progress, which is indicated by greying out the operation button 206 that indicates “In progress . . . ”. Other controls can be included, such as an execution monitor button 208 to access the execution monitor 62 and mobile mirror utility 60, and an AI tools button 210 to access the various AI tools 54, 56, 58, 59 described herein. It can be appreciated that the tools and functions shown in FIG. 12 are illustrative only and other features and information can be provided, for example, within other tabs or via links within the dashboard screen 200.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for automated testing, the device comprising:
a processor;
a communications module coupled to the processor; and
a memory coupled to the processor, the memory storing computer executable instructions that when executed by the processor cause the processor to:
connect via the communications module to a plurality of testing frameworks, each testing framework configured to execute at least one operation in a distinct test or a portion of a multi-stage test on an application under test;
receive first test data and a first test state from a first testing framework of the plurality of testing frameworks, via the communications module;
store the first test data and the first test state in a test repository;
provide the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework;
receive second test data and a second test state from the second testing framework, via the communications module;
store the second test data and the second test state in the test repository in association with the first test data; and
provide access to the test repository upon completion of the multi-stage test or a set of all distinct tests on the application under test.

2. The device of claim 1, wherein the computer executable instructions further cause the processor to:
automatically transition the application under test through multiple distinct tests or the multi-stage test by passing the test data and test states across the plurality of testing frameworks according to at least one transition criterion, via the communications module.

3. The device of claim 1, wherein the computer executable instructions further cause the processor to:
process the first test data or the second test data to be interpretable by the other of the first and second testing frameworks.

4. The device of claim 1, wherein the first and second testing frameworks are each associated with different lines of business in an organization associated with the application under test.

5. The device of claim 4, wherein the application under test comprises mobile and web browser versions requiring testing by each of the plurality of testing frameworks.

6. The device of claim 1, wherein the computer executable instructions further cause the processor to:
map objects in a user interface for the application under test to generate a database file to search for objects in testing the user interface;
store the database file in an objects repository; and
access the database file from the objects repository to execute at least one automated testing feature for at least one of the plurality of testing frameworks.

7. The device of claim 6, wherein the at least one automated testing feature comprises executing a self-healing operation using the database file in the repository.

8. The device of claim 6, wherein the at least one automated testing feature comprises automatically designing a test or test operation using the database file in the repository.

9. The device of claim 6, wherein the at least one automated testing feature comprises performing a visual verification operation to automatically detect and report differences found between screenshots and baselines for the application under test.

10. The device of claim 6, wherein the at least one automated testing feature comprises executing a smart object recognition process by navigating screens in the application to add to or revise the objects repository based on changes made to the application.

11. The device of claim 6, wherein the at least one automated testing feature comprises analyzing automation script failures from a feed of logs for failed scenarios and categorizing failures based on past occurrences.

12. The device of claim 1, wherein the computer executable instructions further cause the processor to monitor application testing by:
executing a test of the application under test on one or more devices;
capturing images of screens during execution of the test;
assembling an animated output using the images; and
displaying the animated output during the test execution to visualize what is occurring on the one or more devices during the test execution.

13. A method of automated testing, the method executed by a device having a communications module and comprising:
connecting via the communications module to a plurality of testing frameworks, each testing framework configured to execute at least one operation in a distinct test or a portion of a multi-stage test on an application under test;
receiving first test data and a first test state from a first testing framework of the plurality of testing frameworks, via the communications module;
storing the first test data and the first test state in a test repository;
providing the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework;
receiving second test data and a second test state from the second testing framework, via the communications module;
storing the second test data and the second test state in the test repository in association with the first test data; and
providing access to the test repository upon completion of the multi-stage test or a set of all distinct tests on the application under test.

14. The method of claim 13, further comprising:
automatically transitioning the application under test through multiple distinct tests or the multi-stage test by passing the test data and test states across the plurality of testing frameworks according to at least one transition criterion, via the communications module.

15. The method of claim 13, further comprising:
processing the first test data or the second test data to be interpretable by the other of the first and second testing frameworks.

16. The method of claim 13, wherein the first and second testing frameworks are each associated with different lines of business in an organization associated with the application under test.

17. The method of claim 16, wherein the application under test comprises mobile and web browser versions requiring testing by each of the plurality of testing frameworks.

18. The method of claim 13, further comprising:
mapping objects in a user interface for the application under test to generate a database file to search for objects in testing the user interface;
storing the database file in an objects repository; and
accessing the database file from the objects repository to execute at least one automated testing feature for at least one of the plurality of testing frameworks.

19. The method of claim 13, further comprising monitoring application testing by:
executing a test of the application under test on one or more devices;
capturing images of screens during execution of the test;
assembling an animated output using the images; and
displaying the animated output during the test execution to visualize what is occurring on the one or more devices during the test execution.

20. A non-transitory computer readable medium for automated testing, the computer readable medium comprising computer executable instructions for:
connecting via a communications module to a plurality of testing frameworks, each testing framework configured to execute at least one operation in a distinct test or a portion of a multi-stage test on an application under test;
receiving first test data and a first test state from a first testing framework of the plurality of testing frameworks, via the communications module;
storing the first test data and the first test state in a test repository;
providing the first test data and the first test state from the test repository to a second testing framework of the plurality of testing frameworks via the communications module, wherein the first test data and the first test state are interpretable by the second testing framework to enable a corresponding distinct test or portion of the multi-stage test on the application under test to be executed by the second testing framework;
receiving second test data and a second test state from the second testing framework, via the communications module;
storing the second test data and the second test state in the test repository in association with the first test data; and
providing access to the test repository upon completion of the multi-stage test or a set of all distinct tests on the application under test.
